(19) United States
(12) Patent Application Publication
(10) Pub. No.: US 2015/0317712 A1
(43) Pub. Date: Nov. 5, 2015

(54) CARD DISTRIBUTION SYSTEM AND METHOD

(71) Applicant: House of Cards, LLC, St. Louis Park, MN (US)

(72) Inventors: Benjamin Bowman, St. Paul, MN (US); David Mitchell, St. Louis Park, MN (US); Jerry St. Sauver, Woodbury, MN (US); Angie Swatfager, Edina, MN (US)

(21) Appl. No.: 14/701,492

(22) Filed: Apr. 30, 2015

Related U.S. Application Data
(60) Provisional application No. 61/986,603, filed on Apr. 30, 2014.

(51) Int. Cl. G06Q 30/06; G06K 15/02

(52) U.S. Cl. CPC G06Q 30/0621; G06K 15/021

(57) ABSTRACT

A system and method for personalizing and dispensing greeting cards and gift cards, wherein a user can use a kiosk to search available greeting cards and gift cards, make a selection, edit the selection, pay for the selection, and dispense the finalized greeting card or gift card from the kiosk. Among other customization options, the system enables the user to change the text, the images, and the language of a selected greeting card or gift card. Additional items such as stamps, pens, stickers, and coupons may be provided to, or purchased by, the user.

### CROSS-REFERENCE TO RELATED APPLICATION

This application claims the benefit of U.S. Provisional Application 61/986,603, filed on Apr. 30, 2014, titled CARD DISTRIBUTION SYSTEM AND METHOD.

### FIELD

The present invention generally relates to a system and method for enabling the on-demand customization and dispensing of greeting cards and gift cards. More specifically, a user can use the disclosed system and method to select a desired greeting card or gift card, personalize it, and dispense it at a kiosk or retail location along with optional items, such as a stamp, pen, sticker, and coupon.

### BACKGROUND OF THE INVENTION

The traditional method of producing and selling greeting cards is antiquated and inefficient. Additionally, there are limited options for specialized types of greeting cards, such as those in other languages or those for non-traditional recipients (ex: a Mother's Day card for a person's sister). Further, e-cards have not proven to be an acceptable alternative to physical greeting cards. Despite the continued need for greeting cards, the overall market has been on the decline due to these issues.

Greeting card production involves the use of large, expensive factories, which drives up the final cost of the greeting card to the consumer. Producers must anticipate the quantity of each card they are going to sell and can end up losing money on cards that are not popular and, thus, not sold. Additionally, the feedback they get and the ability to personally direct advertising is limited since there is not an efficient way for the producers to track who is purchasing the card, how often they purchase cards, the type of cards they traditionally purchase, and the changes consumers would like to see made to the cards.

In addition to production issues, the sale of greeting cards consumes a lot of retail floor space and employee time. Employees must manually order, stock, organize, and re-stock greeting cards. In the days preceding and following a holiday, employees must change out and re-stock greeting cards, which, if not done quickly, can look very messy and unappealing to consumers.

Another problem is that there are limited options for certain types of greeting cards. For example, there are currently very few non-English greeting cards available in the United States, even though increasingly more people in the United States have a first language other than English. Additionally, there are a limited number of options for non-traditional recipients, like a Mother's Day card for a person's sister, and these options are frequently not what a consumer is looking for because they are too funny, not funny enough, not caring, or have too much wording or too many accessories (ex: glitter, cut-outs, etc.).

Lastly, consumers have not embraced e-cards as an acceptable alternative to physical cards. Many people find it much more intimate and satisfying to receive a physical card than an e-card and, therefore, consumers tend to stick to purchasing traditional, physical greeting cards instead of the arguably more convenient and inexpensive alternative of e-cards. Therefore, there is a need in the greeting card market for a more efficient and inexpensive alternative to selling physical greeting cards to consumers.

Similar to greeting cards, the traditional method of obtaining gift cards is also antiquated and inefficient. For example, to obtain a gift card, an individual must usually travel to and purchase a gift card on site at the store where the gift card will be used. Some stores allow individuals to purchase gift cards on their websites. However, the gift cards must still be shipped. Therefore, even if an individual can purchase a gift card for an establishment that is located remotely from the individual, it still takes days to receive the gift card. A system and device is needed that can instantly provide gift cards to individuals for businesses that are not reasonably geographically accessible.

### SUMMARY OF THE INVENTION

The system and method disclosed herein enables a user to electronically search, select, edit, purchase, and dispense a greeting card or gift card and envelope from a kiosk or retail location. Greeting card and gift card options can be made available to a consumer through a mobile application or through the kiosk.

Further, the user can apply a filter to the user's search of available greeting cards, can add text, replace images, or change the language on a selected greeting card, can receive a coupon that is related to the type of greeting card the user selected, and can use the system to receive or purchase other items such as, but not limited to, stamps, pens, coupons, and stickers, which may also be personalized using the methods described herein.

### BRIEF DESCRIPTION OF THE DRAWINGS

FIG. 1 is an example graphical user interface showing a screen saver according to one embodiment of the present invention.

FIG. 2 is an example graphical user interface showing available greeting card filters according to one embodiment of the present invention.

FIG. 3 is an example graphical user interface showing a selected greeting card according to one embodiment of the present invention.

FIG. 4 is an example graphical user interface showing a checkout cart according to one embodiment of the present invention.

FIG. 5 is an example graphical user interface showing that a greeting card has been added to a user's cart according to one embodiment of the present invention.

FIG. 6 is an exemplar kiosk that enables a user to access and use the disclosed system and method according to one embodiment of the present invention.

FIG. 7 is a schematic block diagram depicting an example computing system used in accordance with one embodiment of the present invention.

### DETAILED DESCRIPTION

Various user interfaces and embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims. It is understood that various omissions and substitutions of equivalents are contemplated as circumstances may suggest or render expedient, but these are intended to cover application or embodiments without departing from the spirit or scope of the claims attached hereto. Also, it is to be understood that the phraseology and terminology used herein are for the purpose of description and should not be regarded as limiting.

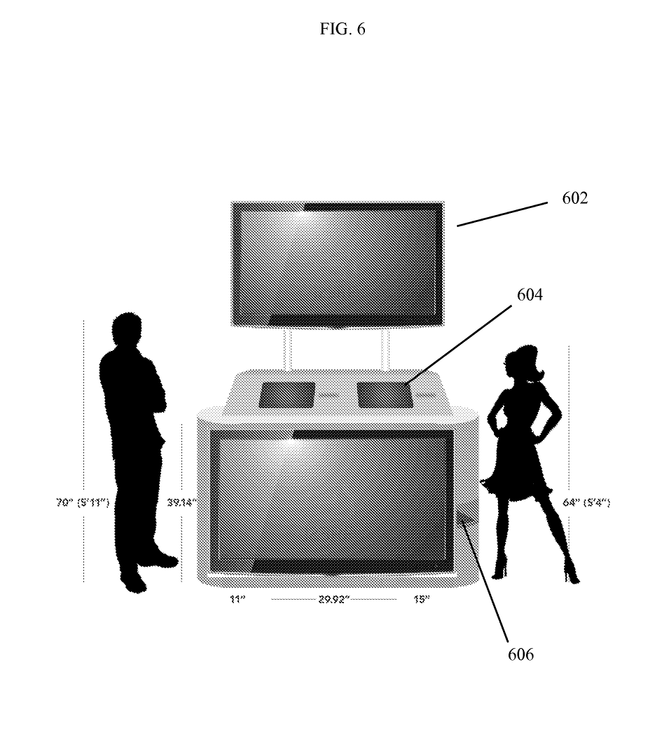

In general terms, the system and methods described herein enable an individual to search, select, edit, purchase, and print a greeting card and envelope from a kiosk, as illustrated in FIG. 6, or retail location. In one embodiment, an individual can pre-select a card on a mobile application or website, receive a code, and enter that code at the kiosk 600 or retail location to receive the card and envelope.

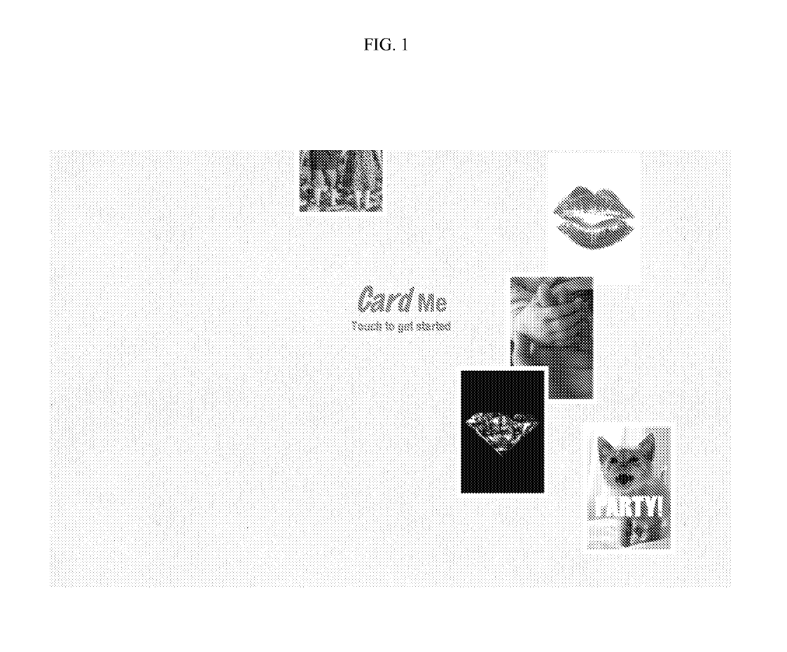

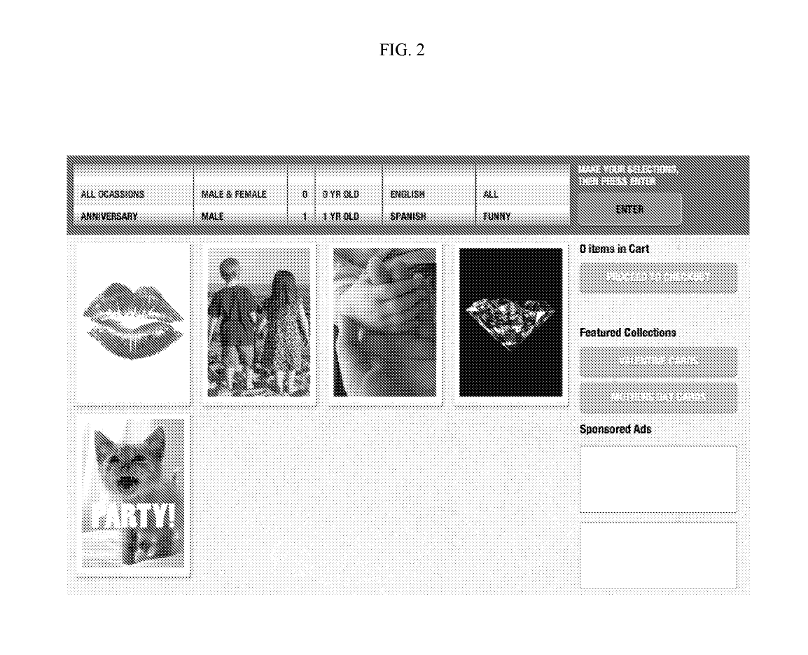

To use the system on a kiosk 600, the user can tap a screen to get started, as illustrated in FIG. 1. When searching for a greeting card at a kiosk 600 or through a mobile application or website, a user can filter card options by one or more categories such, but not limited to, occasion (e.g., birthday, anniversary, Mother's Day, etc.), sex, age, mood (e.g., funny, serious, sentimental, etc.), and brand, as illustrated in FIG. 2. A user may also be able to choose a specific envelope color or pattern once the card has been selected. Further, in one embodiment, a user can enter in his or her name and address and the recipient's name and address, and the system can transfer and print that information onto the envelope.

The system can support a massive library of greeting card options. Further, in one embodiment of the currently disclosed system, the system can support the same cards in several different languages. In one embodiment, card content can be added to the system through mechanisms such as, but not limited to, crowdsourcing, direct input from current card makers and distributors, user-created libraries, and through purchasing a library of already-created content from an artist. Crowdsourcing in this sense refers to a group of unrelated individuals creating and uploading card content onto the system's mobile application or website and, wherein, that content is then available for other users to purchase. An administrator can then receive a notification that new content has been uploaded and can review the uploaded cards to ensure the content is appropriate. In another embodiment, current card makers and distributors can submit portfolios of card content to an administrator who can then upload all of the content accordingly.

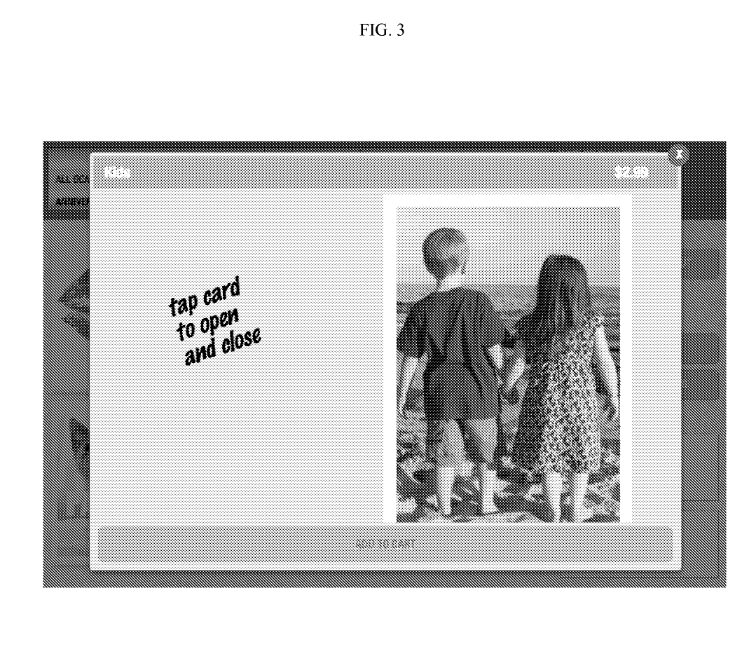

When searching through cards, in one embodiment, a user can be presented with just the front cover and can select a card in order to view the inside and back cover of the card, as illustrated in FIG. 3. Once a user selects a card, the user can, in one embodiment, swap out the provided images, photo, or art, for more applicable ones that are available to the user through the system or, in one embodiment, from a user's personal library of images, photos, or art. Additionally, the system can permit a user to personalize a greeting card by typing out a message before the card is printed. This is helpful for users who prefer not to handwrite messages. Alternatively, the system could provide a touch-sensitive surface that will render a hand-drawn message and/or signature on the card with the appearance of handwriting.

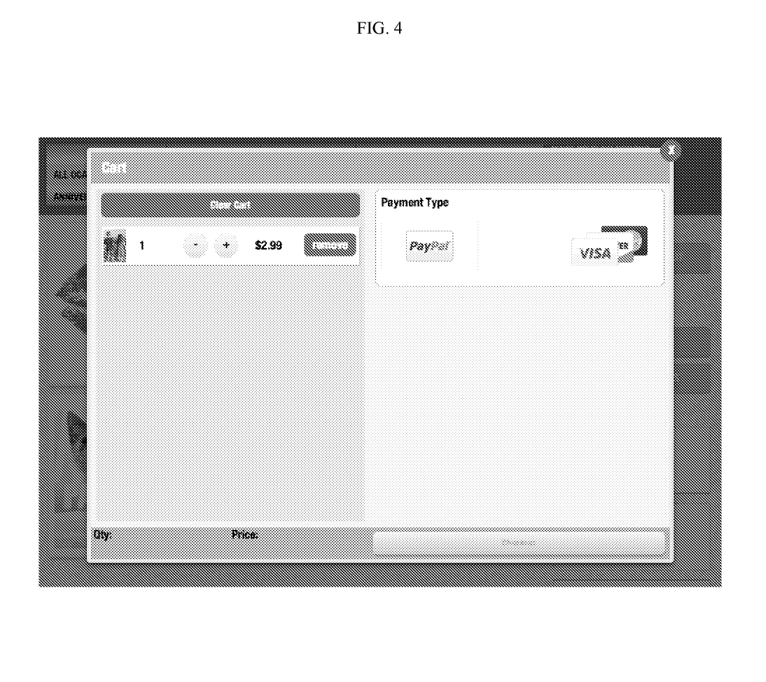

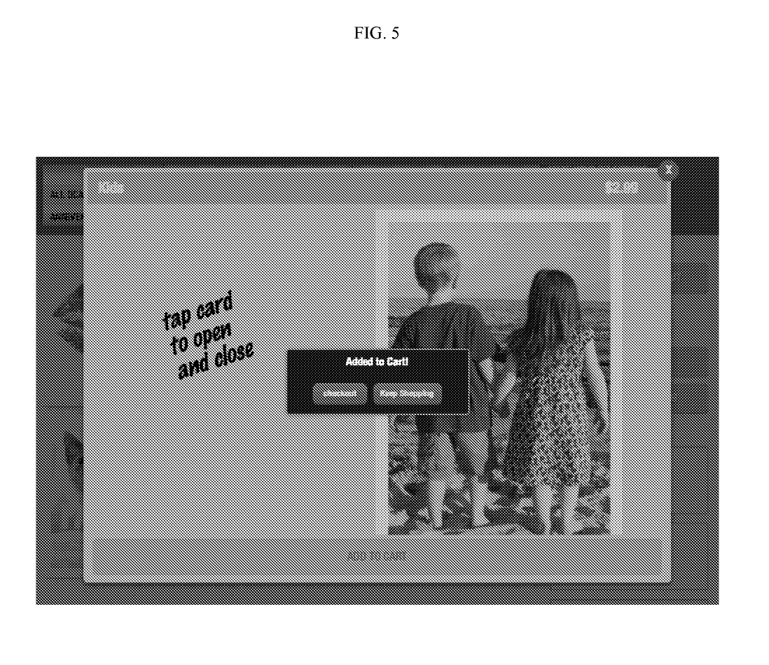

Once a user has selected and made any desired edits to a card, the user can select the payment type and add the card to the user's cart, as illustrated in FIG. 4. In one embodiment, the user will be notified via a popup message that the card has been added to the user's cart, as illustrated in FIG. 5. Alternatively, a user can search, select, edit, and/or purchase the card prior to getting to a location where he or she will print the card. In this embodiment, the system can generate a code for the user to enter when the user gets to a location that has the ability to print the card and envelope.

In one embodiment, the system can be a stand-alone kiosk, as illustrated in FIG. 6, located in a retail location such as, but not limited to, an airport, retail store, coffee shop, shopping mall, hotel, gas station, post office, hospital, toy store, university or other school, post office, or a FedEx/Kinkos Retail stores where the system could be implemented include, but are not limited to, CVS, Walgreens, Rite Aid, Target, WalMart, Costco, and Menards.

The kiosk 600 can have a large screen on top 602, at least one touch screen 604, a printer, a door to allow access to the inside of the kiosk 600 for maintenance, and slots 606 to distribute the card, envelope, receipt, stamp, pen, and any other item that can be distributed to a user. The screen on top 602 can be used for various purposes such as, but not limited to, showing a demo of how the system works or advertising. The touch screen 604 can be used to show the user interface that guides a user through the purchase of a greeting card. The printer can be located inside the kiosk 600 and can range in size from an ATM machine to a large, freestanding kiosk. One example of a printer that operate with the system is the Xerox Phaser 7800 printer.

The kiosk 600 can support one or more users who are simultaneously searching, selecting, editing, purchasing, and printing greeting cards. Further, in one embodiment, the kiosk 600 can allow a user to login to his or her social media account and display friends' or connections' birthdays, anniversaries, or other relevant celebratory days that the user's friends or connections are sharing on their social media webpage.

In one embodiment, the system may not require a kiosk 600. For example, a user can search, find, edit, and purchase a card and envelope through the use of a mobile application or website and then print the card at a retail location such as, but not limited to, a FedEx/Kinkos or post office.

In addition to purchasing greeting cards, in one embodiment, an individual may be able to purchase additional items such as, but not limited to, stamps, pens, stickers, and gift cards. In one embodiment, the user can print a sheet of stickers that contain the return address information of the user. In another embodiment, the system can target a customer based on his or her greeting card selection and automatically print coupons for the appropriate recipient. For example, if an individual purchases a greeting card for a girl's eighth birthday, the system can print a coupon for a Mattel Barbie doll.

In one embodiment, a user may be able to purchase a gift card from the kiosk, wherein the gift card may be personalized. The gift card selection can be limited by geographical location. For example, the gift card selection can include gifts cards for establishments in the physical vicinity to the kiosk or gift cards for establishments in the physical vicinity of the recipient, which can be established when the user inputs the recipient's address. In another embodiment, the gift card selection can include gift cards for online retailers.

Once a user chooses from the gift card selection, the user can further personalize the gift card. The user can select the amount of money to load onto the gift card, can pick a pattern for the gift card, can pick an image or picture to put on the gift card, or can include text on the card. The monetary amount can be chosen from fixed intervals (ex: $10, $25, $50, etc.) or can be manually entered (ex: $20.15 for a person graduating in 2015). The kiosk may have a variety of patterns for the user to choose from to place on the card. Alternatively, the user may be able to upload a pattern onto the kiosk or, if designing the gift card online, onto the website to place on the gift card. Similarly, the user may be able to upload an image or picture for placement on the gift card. The text a user can include on the gift card can allow a user to personalize the gift card as well. For example, a user can include short phrases such as “Happy Graduation John!” The user may also be able to include text to indicate to whom the gift card is for and to whom it is from. In some embodiments, the user may be limited to a certain number of characters for the text portion of the gift card.

In one embodiment of the disclosed system and method, the system can identify consumers through the use of a user account and can track the kind of cards they purchase and their frequency of purchases. This enables the system to learn and remember specific information about each user, which then enables the use of relevant card suggestions, coupons, and advertisements. Alternatively, the system can identify consumers through the use of their credit cards.

In another embodiment, if the system is located in a retail establishment, it can target a customer based on that person's presence in the store. For example, if a person is using the system in an airport, it may print a coupon for a discounted coffee drink at a coffee establishment in the airport. One benefit to this use of targeted couponing is that the user is still located in the store where the coupon can be used.

In one embodiment, the kiosk 600 may display relevant advertising to a user purchasing a specific type of card. For example, if a user is purchasing a birthday card for a 40 year-old man, the kiosk 600 may display, on the same or a separate screen, an advertisement for Sears' Craftsman tools. In another embodiment, the mobile application or website can display relevant advertising to a user searching in a specific area of cards.

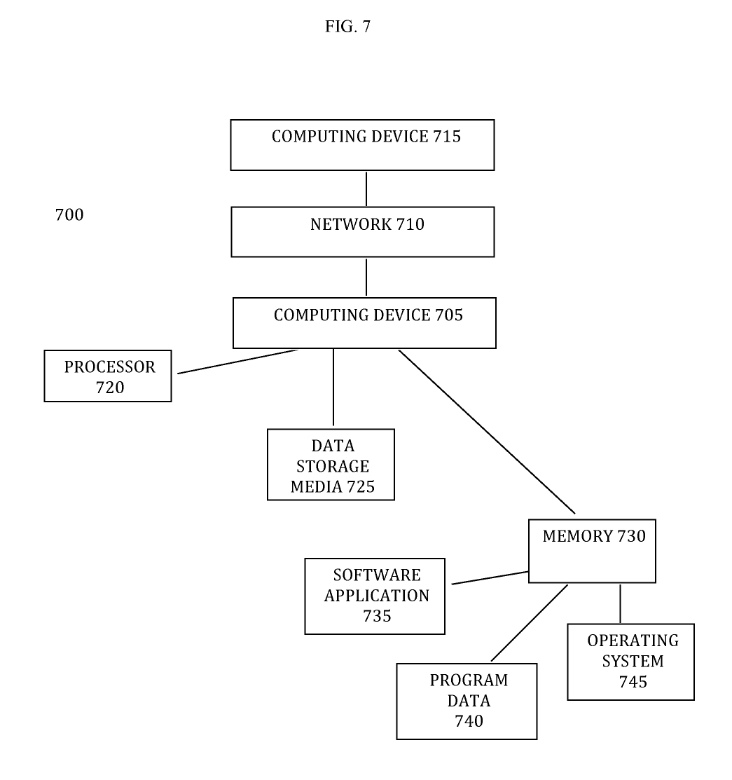

In some embodiments, the system described herein uses a computing system to carry out the various functions described herein. FIG. 7 is a schematic block diagram of an example computing system 700. The example computing system includes at least one computing device 702. In some embodiments the computing system further includes a communication network 704 and one or more additional computing devices 706 (such as a server).

The computing device 702 can be, for example, located in a mall or shopping establishment or can be a computing device located in a user's home or other place of business. In some embodiments, computing device 702 is a mobile device. The computing device 702 can be a stand-alone computing device or a networked computing device that communicates with one or more other computing devices 706 across a network 704. The additional computing device(s) 706 can be, for example, located remotely from the first computing device 702, but configured for data communication with the first computing device 702 across a network 704.

In some examples, the computing devices 702 and 706 include at least one processor or processing unit 708 and system memory 712. The processor 708 is a device configured to process a set of instructions. In some embodiments, system memory 712 may be a component of processor 708; in other embodiments system memory is separate from the processor. Depending on the exact configuration and type of computing device, the system memory 712 may be volatile (such as RAM), non-volatile (such as ROM, flash memory, etc.) or some combination of the two. System memory 712 typically includes an operating system 718 suitable for controlling the operation of the computing device, such as the WINDOWS® operating systems or the OS X operating system, or a server, such as one employing Windows SharePoint or OS X. The system memory 712 may also include one or more software applications 714 and may include program data 716.

The computing device may have additional features or functionality. For example, the device may also include additional data storage devices 710 (removable and/or non-removable) such as, for example, magnetic disks, optical disks, or tape. Computer storage media 710 may include volatile and nonvolatile, removable and non-removable media implemented in any method or technology for storage of information, such as computer readable instructions, data structures, program modules, or other data. System memory, removable storage, and non-removable storage are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device. An example of computer storage media is non-transitory media.

In some examples, one or more of the computing devices 702, 706 can be located in a kiosk or an establishment, such as an airport, shopping mall, or post office. In other examples, the computing device can be a personal computing device that is networked to allow the user to access and utilize the system disclosed herein from a remote location, such as in a user's home, office or other location. In some embodiments, the computing device 702 is a smart phone tablet, laptop computer, personal digital assistant, or other mobile device. In some embodiments system operations and functions are stored as data instructions for a smart phone application. A network 704 facilitates communication between the computing device 702 and one or more servers, such as an additional computing device 706 that hosts the system. The network 704 may be a wide variety of different types of electronic communication networks. For example, the network may be a wide-area network, such as the Internet, a local-area network, a metropolitan-area network, or another type of electronic communication network. The network may include wired and/or wireless data links. A variety of communications protocols may be used in the network including, but not limited to, Wi-Fi, Ethernet, Transport Control Protocol (TCP), Internet Protocol (IP), Hypertext Transfer Protocol (HTTP), SOAP, remote procedure call protocols, and/or other types of communications protocols.

In some examples, the additional computing device 706 is a Web server. In this example, the first computing device 702 includes a Web browser that communicates with the Web server to request and retrieve data. The data is then displayed to the user, such as by using a Web browser software application. In some embodiments, the various operations, methods, and functions disclosed herein are implemented by instructions stored in memory. When the instructions are executed by the processor of the one or more computing devices 702 or 706, the instructions cause the processor to perform one or more of the operations or methods disclosed herein. Examples of operations include the ability to search, select, purchase and dispense a greeting card or gift card, among others.

The various embodiments described above are provided by way of illustration only and should not be construed to limit the claims attached hereto. Those skilled in the art will readily recognize various modifications and changes that may be made without following the example embodiments and applications illustrated and described herein and without departing from the true spirit and scope of the following claims.

I claim:

1. A method of personalizing and printing greeting cards, the method comprising:
utilizing a networked computing device having a processing device and a memory device, the memory device storing information that, when executed by the processing device, causes the processing device to:
enable a user to search available greeting cards;
enable the user to select at least one greeting card;
enable the user to edit the at least one selected greeting card;
accept payment for the at least one selected greeting card; and
send the at least one selected greeting card to a printer.

2. The method of claim 1, wherein the user applies a filter to the user's search of available greeting cards.

3. The method of claim 1, wherein the edit to the at least one selected greeting card comprises adding text to the greeting card.

4. The method of claim 1, wherein the edit to the at least one selected greeting card comprises replacing at least one image on the greeting card with a different image.

5. The method of claim 1, wherein the edit to the at least one selected greeting card comprises changing the language on the card.

6. The method of claim 1, wherein the device uses the selected greeting card to find, and send to a printer, a coupon for the user that is related to the type of greeting card the user selected.

7. The method of claim 1, wherein the networked computing device having a processing device and a memory device is located inside of a kiosk.

8. The method of claim 7, wherein the kiosk also contains the printer.
